(19) United States
(12) Patent Application Publication
(10) Pub. No.: US 2013/0032544 A1
(43) Pub. Date: Feb. 7, 2013

(54) Systems and methods for reducing phosphorous in phosphorous-containing outflows

(71) Applicants: Aleksandra Drizo, Bedford (CA); Hugo Picard, Bedford (CA)

(72) Inventors: Aleksandra Drizo, Bedford (CA); Hugo Picard, Bedford (CA)

(73) Assignee: UNIVERSITY OF VERMONT AND STATE AGRICULTURAL COLLEGE

(21) Appl. No.: 13/136,646

(22) Filed: Aug. 5, 2011

(51) Int. Cl. C02F 1/28; B01D 15/00; C02F 1/00; C02F 101/10

(52) U.S. Cl. 210/669; 210/130

(57) ABSTRACT

Systems and methods for removing phosphorous (P) from P-containing wastewater from agricultural and urban outflow sources are disclosed. The system includes at least one water attenuation unit (WAU) fluidly coupled to at least one main filter unit (MFU) that contains P-adsorbing material. A high-flow diverter unit is arranged between the WAU and the MFU and diverts a portion of the flow of influent wastewater at high flow rates. The P-filter system is compact and has a modular construction. The effluent wastewater discharged from the P-filter system has 60% to 90% less phosphorous than the influent wastewater.

### STATEMENT OF GOVERNMENTAL SUPPORT

This invention was made with U.S. government support under Grant No. WQ-319-10 awarded by the United States Environmental Protection Agency. The U.S. government therefore has certain rights in this invention.

### FIELD OF THE DISCLOSURE

The present disclosure relates generally to the treatment and control of outflows that contain phosphorous, and in particular to systems and methods for reducing the amount of phosphorous in phosphorous-containing outflows.

### BACKGROUND ART

Over the course of human history, on-site wastewater treatment systems have evolved from pit privies to installations capable of producing a disinfected effluent fit for human consumption. Modern conventional on-site wastewater treatment systems consist primarily of a septic tank and a soil absorption field, also known as a subsurface wastewater infiltration system.

Outflows from agricultural and urban sources in the form of wastewater discharges typically include pollutants in the form of nitrogen (N), phosphorous (P), suspended solids, and disease-causing pathogens. Of these, problems associated with P pollution have been recognized as an increasing worldwide concern due to the role of P in accelerating eutrophication. Consequently, governmental agencies across the world have established or are in the process of establishing regulations for wastewater discharges originating from point sources, such as municipal treatment plants, industry discharges from factories, houses, housing developments, etc., as the most expedient means of reducing P pollution. The more stringent regulations increase the cost of treating wastewater from point pollution sources, and motivate the need for new technologies that provide efficient P removal from P-containing outflows from both agricultural and urban sources.

### SUMMARY

An aspect of the disclosure is a P-filter system for removing P from an influent wastewater having an initial P concentration and flow rate in a downstream direction and that carries solid material. The system includes at least one water attenuation unit (WAU) configured to receive and attenuate the initial flow rate of the influent wastewater and to allow settling of the solid material carried by the influent wastewater. The system also includes at least one main filter unit (MFU) arranged downstream of and in fluid communication with the at least one WAU. The at least one MFU includes P-adsorbing material that forms from the P-containing wastewater an effluent wastewater that contains less P than the influent wastewater. The system also has a high-flow diverter operably disposed between the at least one WAU and the at least one MFU. The high-flow diverter is configured to divert at least a portion of the influent wastewater from the at least one WAU from reaching the at least one MFU when the initial flow rate increases to a threshold flow rate.

Another aspect of the invention is a method of filtering an outflow of influent wastewater that contains a first amount of P. The method includes flowing the influent wastewater through at least one WAU to reduce a flow rate of the influent wastewater and to reduce an initial amount of total suspended solids in the influent wastewater. The method also includes flowing the influent wastewater from the at least one WAU to and through at least one MFU that contains a P-adsorbing material to form an effluent wastewater that is discharged from the at least one MFU. The effluent wastewater has a second amount of P less than the first amount of P. The flowing of the influent wastewater from the at least one WAU to the at least one MFU includes diverting a portion of the influent wastewater from the at least one WAU from reaching the at least one MFU when initial flow rate reaches a threshold flow rate.

Additional features and advantages of the disclosure will be set forth in the detailed description that follows, and will be readily apparent to those skilled in the art from that description or recognized by practicing the disclosure as described herein, including the detailed description which follows, the claims, and the appended drawings.

It is to be understood that both the foregoing general description and the following detailed description present embodiments of the disclosure and are intended to provide an overview or framework for understanding the nature and character of the disclosure as it is claimed. The accompanying drawings are included to provide a further understanding of the disclosure and are incorporated into and constitute a part of this specification. The drawings illustrate various embodiments of the disclosure and together with the description serve to explain the principles and operations of the disclosure. The claims set forth below are incorporated into and constitute part of the Detailed Description as set forth below.

### BRIEF DESCRIPTION OF THE DRAWINGS

FIG. 1A is a top-down view of an example P-filter system according to the disclosure;

FIG. 1B is a side-view of the example P-filter system of FIG. 1A, showing an example of how the P-filter system can be arranged underground;

FIG. 1C is view of the high-flow diverter looking in the y-direction and illustrating the selectability/adjustability of angle of the diverter pipe, and also showing an optional pressure-sensitive flap for controlling the overflow of influent wastewater through the high-flow diverter;

FIG. 2A is a close-up isometric side view of an example main filter unit (MFU) of the P-filter system of FIGS. 1A and 1B;

FIG. 2B is a front-on view of the MFU of FIG. 2A, illustrating an example of how the P-adsorbing material fills the interior of the MFU in a manner that leaves some freeboard to accommodate influent wastewater overflow;

FIG. 3 is a schematic side view of an example P-filter system that includes two branches (B1 and B2) that reside one above the other and that each include at least one MFU;

FIG. 4 is a schematic top-down view of an example P-filter system that includes two branches (B1 and B2) that reside in substantially the same plane;

FIG. 5A is a schematic diagram of an example P-filter having a single branch that extends downward into the ground and that includes multiple MFUs fluidly connected by connector pipes;

FIG. 5B is similar to FIG. 5A except that the multiple MFUs are fluidly connected by being arranged immediately adjacent one another at their respective output and input ends;

FIG. 6 is a close-up, cross-sectional view illustrating an example where MFUs in the P-filter system are arranged immediately adjacent one another, i.e., without an intervening connector pipe, such as shown in FIG. 5B; and

FIGS. 7A and 7B illustrate an example P-filter system that includes two branches B1 and B2, where branch B1 includes an influent wastewater overflow discharge pipe having an open end.

The various elements depicted in the drawing are merely representational and are not necessarily drawn to scale. Certain sections thereof may be exaggerated, while others may be minimized. The drawings are intended to illustrate example embodiments of the disclosure that can be understood and appropriately carried out by those of ordinary skill in the art. The claims are incorporated into and constitute part of the Detailed Description as set forth below.

### DETAILED DESCRIPTION

The present disclosure relates generally to reducing the amount of P in P-containing wastewater outflows such as from agricultural and urban outflows. Sources of agricultural outflows include agricultural tile drains and animal heavy use areas such are barnyards, feed bunks, silage leachate runoff, and the like. Sources of urban outflows include stormwater outflows, onsite disposal systems such as leachate fields, gardens, parking lot runoff, golf course runoff and the like.

U.S. Patent Application Pub. No. 2008/00778720 A1, having U.S. patent application Ser. No. 11/862,765, filed on Sep. 27, 2006, and entitled “System and method for removing phosphorous from non-point pollution sources” and U.S. patent application Ser. No. 12/807,177, filed on Aug. 30, 2010 and entitled “Systems and methods for removing phosphorous from wastewater” are incorporated by reference herein.

Cartesian coordinates are shown in some of the Figures for reference and not by way of limitation with respect to particular directions. In the description herein, the terms “upstream” and “downstream” are relative to the direction of the flow of wastewater 250I, which in the Figures is shown generally as being from left to right, that is, in the +y direction.

Also in the description herein, amounts of P can be divided into three components: soluble reactive phosphorous (SRP) or soluble inorganic P; soluble unreactive or soluble organic phosphorous (SOP); and particulate phosphorous (PP), with the sum of SRP and SOP being called soluble or “dissolved” P. Dissolved P and PP are differentiated by whether or not they pass through a 0.45 micron-membrane filter. “Total P” (TP) includes the sum of all P components (SRP, SOP and PP). It is generally accepted in the art that 90% of phosphorous in sewage wastewater is in dissolved inorganic form.

### P-Filter System

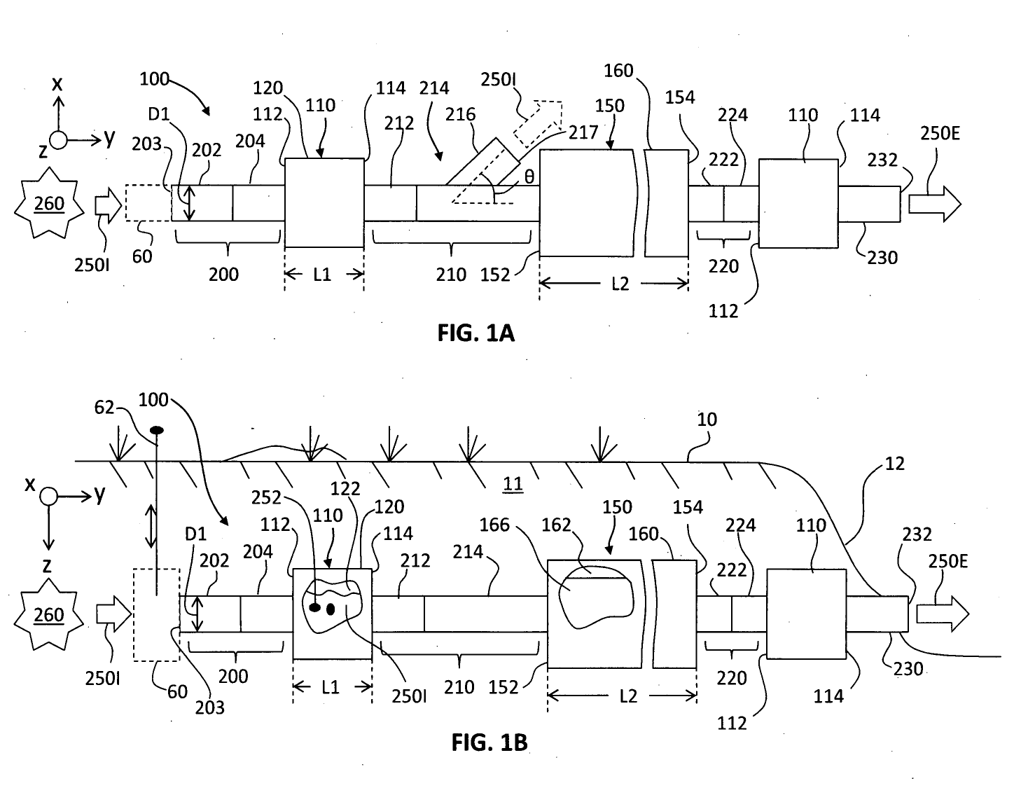

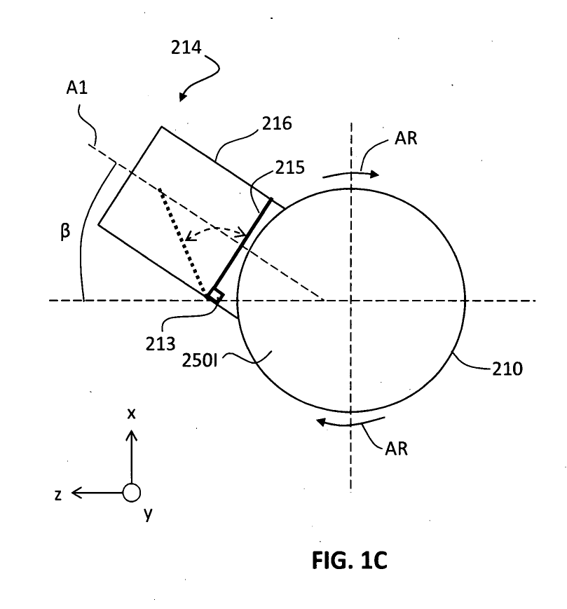

FIG. 1A is a top-down view of a P-filter system 100. The P-filter system 100 of FIG. 1A can be considered as being implemented above the ground surface (see ground surface 10 as shown in FIG. 1B). The P-filter system 100 can be implemented above or below ground surface 10. FIG. 1B is a cross-sectional view of an example embodiment of P-filter system 100. The ground surface 10 of ground 11 is shown for reference only in FIG. 1B and illustrates an example embodiment wherein P-filter system 100 is arranged in ground 11 beneath ground surface 10. Other embodiments of P-filter system 100 can include some or all of the main system components being above ground surface 10. An outflow source 260 that provides influent wastewater 250I into P-filter system 100 defines the upstream end of the P-filter system. In an example, P-filter system 100 is oriented at an angle relative to gravity so that the flow of influent wastewater 250I is assisted by gravity.

The P-filter system 100 generally includes at least one water attenuation unit (WAU) 110 fluidly coupled to at least one main filter unit (MFU) 150. The example P-filter system 100 shown in FIGS. 1A and 1B shows two WAUs 110 by way of illustration, with one being operably disposed on the upstream side of MFU 150 and one being operably disposed on the downstream side of MFU 150. In an example, P-filter system 100 includes at least one upstream WAU 110.

With continuing reference to FIGS. 1A and 1B, upstream and downstream WAUs 110 each have input and output ends 112 and 114, while MFU 150 is arranged in between the WAUs and has input and output ends 152 and 154. The P-filter system 100 includes an input pipe 200 that fluidly connects to an input end 112 of upstream WAU 110. In an example, input pipe 200 includes an input section 202 coupled to a second section 204. The input section 202 has an open end 203 and in an example comprises a rubber boot.

An example of system 100 optionally includes a flow control structure 60 fluidly connected to input pipe 200 at open end 203. The flow control structure 60, which is shown in phantom, is configured to control the amount of flow of influent wastewater 250I. In an example, flow control structure 60 includes an adjustable flow control member 62 that can be manually adjusted (e.g., moved up and down) to control the amount of flow of influent wastewater 250I. The adjustable flow control member 62 is best located upstream of the upstream WAU 110 and is shown as part of flow control structure 60 by way of example.

An example flow control structure 60 suitable for system 10 is available from Agri-Drain Corporation of Adair, Iowa, and is called the Inline Water Level Control Structure™. When flow control structure 60 is not used, influent wastewater 250I can enter open end 203 directly from outflow source 260. Alternatively, system 10 can be connected to any other kind of upstream system or device (not shown) that processes or otherwise carries influent wastewater 250I and that fluidly connects system 10 to outflow source 260. The flow control structure 60 is just one example of such an upstream system or device. Another example of such an upstream device is another P-filter system.

The P-filter system 100 also includes a connector pipe 210 that fluidly connects output end 114 of upstream WAU 110 to input end 152 of MFU 150. In an example, connector pipe 210 includes a first input section 212 and a second V-shaped section 214 downstream of the first input section. The V-shaped section 214 is defined in part by a short pipe section (“diverter pipe”) 216 having an open end 217. The diverter pipe 216 is angled at a pipe angle θ so that a portion of influent wastewater 250I from upstream WAU 110 can be made to flow out of output end 217 and be discharged generally in the downstream direction, that is, has a component of its flow in the downstream (+y) direction. The V-shaped section 214 represents an example embodiment of a high-flow diverter or HFD and so is referred to hereinafter as HFD 214. The short pipe section 216 can comprise a rubber boot. Note that in FIG. 1B, short pipe section 216 is hidden from view. One of the benefits of HFD 214 is that it can reduce or eliminate adverse effects of the backup of influent wastewater 250I in high-flow conditions.

With reference to FIG. 1C, HDF 214 need not lie in the X-Y plane but can be angled at any angle β (shown as measured relative to the z axis and an HDF axis A1) that facilitates the outflow of influent wastewater 250I in overflow situations. In an example, angle β is adjustable by rotating connector pipe 210 (as indicated by arrows AR), which may be connected to MFU 150 via threads or another type rotatably adjustable mechanism.

In an example, HDF 214 includes a pressure-sensitive flap 215 configured to open (as shown in the dotted-line phantom depiction) when the pressure presented by influent wastewater 250I is sufficiently high, i.e., when it reaches a threshold flow rate. In an example, pressure-sensitive flap 215 includes a spring-based hinge 213 configured to provide a spring-based restoring force to keep flap 215 in a closed position when the pressure from influent wastewater 250I is below a select pressure threshold.

The P-filter system 100 also includes a first output pipe 220 that fluidly connects output end 154 of MFU 150 to input end 112 of downstream WAU 110. The first output pipe 220 includes first and second sections 222 and 224. The first output pipe section 220 may comprise a rubber boot.

The P-filter system 100 also includes a second or main output pipe 230 fluidly connected to downstream WAU 110 at output end 114. The main output pipe 230 has an open end 232. In FIG. 1B, main output pipe 230 is shown extending from a sloped portion 12 of ground surface 10.

In an example, pipes 200, 210, 220 and 230 include PVC pipe. In an example, pipes 200, 210 and 220 are preferably sealed so that fluid communication therethrough is watertight. An example diameter D1 of pipes 200, 210, 220 and 230 ranges from 4 inches to 12 inches.

The P-filter system 100 is generally configured to receive P-containing influent wastewater 250I either directly or indirectly from P-containing outflow source 260 at input pipe 200 and to output an effluent wastewater 250E from open end 232 of pipe 230. The P-filter system 100 is configured such that effluent wastewater 250E has substantially less P than influent wastewater 250I. In an example, influent wastewater 250I includes (e.g., carries in suspension) solid material 252. In an example, influent wastewater 250I includes an initial amount of solid material 252, also referred to as Total Suspended Solids (TSS).

The example P-filter system 100 of FIG. 1B is configured to operate in a subsurface mode, i.e., below ground surface 10, and is configured to receive P-containing wastewater 250I running substantially lateral to and beneath the ground surface. However, other modes of operation and configurations for P-filter system 100 can be employed, such as for example feeding in a vertical mode (from the top down) or even from the bottom to the top. Various configurations for P-filter system 100 beyond those shown in FIGS. 1A and 1B are described below.

With continuing reference to FIGS. 1A and 1B, WAU 110 is configured to attenuate the flow of P-containing influent wastewater 250I traveling in input pipe 200 and to facilitate the settling of any solid material 252 in the influent wastewater. The WAU 110 includes a container 120 that defines a container interior 122 that in one example is substantially empty so that it can accommodate and store an amount of influent wastewater 250I. The container 120 may be made of plastic, concrete, fiberglass or another prefabricated material and can optionally have a removable top (not shown) to facilitate access to container interior 122 by system operators for system maintenance. Example dimensions for a square container 120 are 8 inches wide (x, z directions) by 12 inches long (y direction), which provides an example volume of 768 cubic inches.

The MFU 150 includes a container 160 that defines an interior 162. The container 160 may be made of plastic, concrete, fiberglass or another prefabricated material (or combinations thereof) that is substantially resistant to corrosion or environmental degradation when buried underground. Example dimensions for a cylindrical container 160 are diameter D2=1 ft and length L2=6 ft. The container 160 can have any shape suitable for the P-adsorbing material to perform its P-filtering function. In an example, a cylindrical container 160 with a round or oval cross-section is readily provided using existing PVC pipe or other type of pipe material, or by modifying the existing pipe.

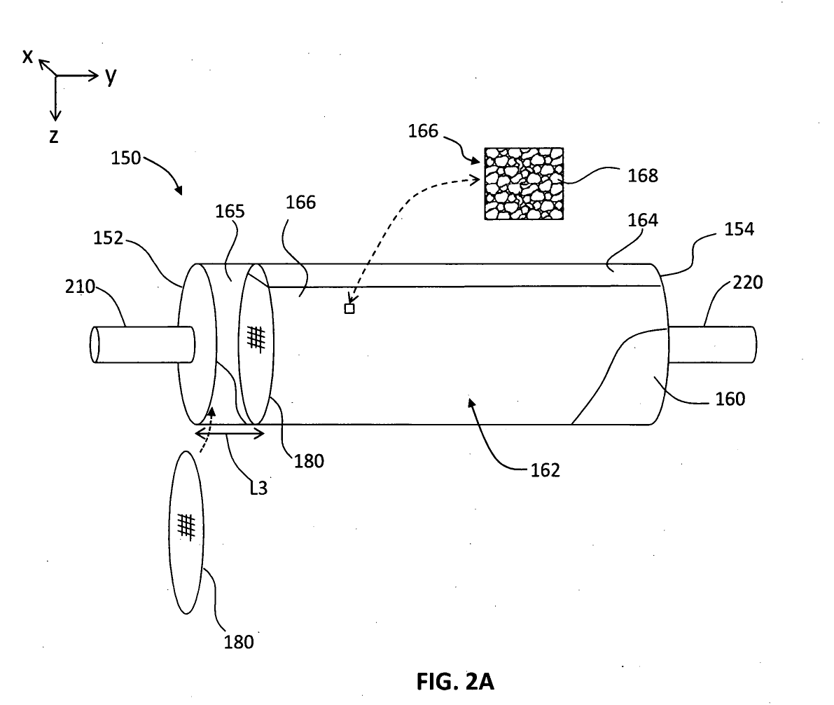

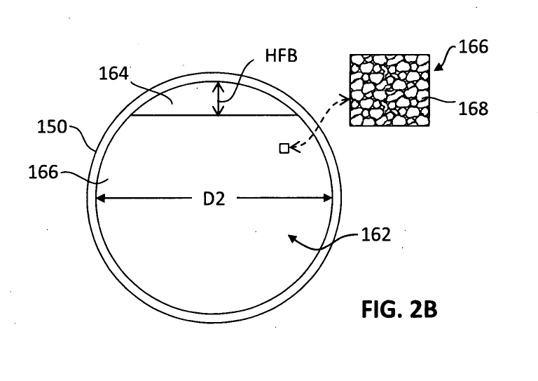

With reference now to FIGS. 2A and 2B, container interior 162 is at least partially filled with a mass 166 of loose pieces 168 of P-adsorbing material, such as steel slag, crushed or palletized material (e.g., calcium and/or iron based adsorbing material) having the ability to remove phosphorous from P-containing wastewater. Combinations of different P-adsorbing materials can be used to constitute mass 166.

In an example, container interior 162 is partially filled with mass 166 so that a region 164 of the container interior near the top of container 160 remains empty. In an example, interior region 164 has a dimension HFB greater than about 1 inch and more preferably greater than about 2 inches to provide freeboard that allows influent wastewater 250I to more freely flow within container interior 162. The interior region 164 is thus referred to hereinbelow as freeboard interior region 164. An MFU 150 having a circularly cylindrical container 160 with a diameter D2=8 inches and a freeboard dimension of HFB=2 inches can contain approximately 50 kg of P-adsorbing material (i.e., mass) 166 per 1 meter (˜39 inches) of length L2.

To prevent or reduce clogging, it is advantageous that P-adsorbing material 166 have a specific size distribution for pieces (i.e., particles) 168. In an example, a particle size with a diameter of 10-30 mm facilitates P removal while reducing or preventing clogging.

Various types of steel slag are known to have the ability to adsorb a substantial amount of P and are thus suitable for use as the P-adsorbing material (mass) 166 for MFU 150. Slag is produced, for example, from steelmaking processes and so is generated in steel mills where iron ore is melted in blast furnaces (BF slag). Slag is also produced in electric arc furnaces (EAFs) or “mini-mills” by melting scrap steel. EAF steel slag has very favorable P retention and sequestration properties. However, other steel slag types (e.g., BF, Basic Oxygen Slag (BOF)) can be used as P-adsorbing material 166 in MFU 150.

When steelmaking slag is used as P-adsorbing material 166, MFU 150 removes (i.e., sequestrates) P from P-containing influent wastewater 250I by specific absorption on metal hydroxides or through precipitation, for example, Fe—P precipitation and formation of the Fe(II) mineral vivianite (Fe₃(PO₄)₂.8H₂O) and calcium phosphate precipitation (e.g., hydroxyapatite (HAP)) via the slag and by bacterial uptake at specific HRTs. Consequently, a P-filter system that utilizes such slag is inexpensive, has minimal land requirements, requires little or no energy (depending on whether pumps are used), and offers flexibility in installation.

Steelmaking slag is also highly efficient (i.e., 85%-100%) in removing P from point pollution sources as well as from non-point (i.e., diffuse) pollution sources; for example, steelmaking slag can remove about 70% to about 90% of P and about 40% to about 80% of suspended solids from agricultural runoff (e.g., farm ditches, drainage tiles, culverts, manure and feedbunks leachate, etc.) that contains various (total) P concentrations, for example, concentrations as low as 0.1 mg/L and as high as 100 mg/L. In an example, the sequestrated P is plant bio-available and can be reused as soil amendment to support plant growth in horticulture, forestry, agriculture or vegetation re-establishment in acid mines reclamation.

In addition to freeboard interior region 164, interior 162 of container 160 of MFU 150 includes a front-end interior region 165 adjacent MFU front end 152 (see FIG. 2A). In an example, front-end interior region 165 has a length L3 of least 0.1 m. The front-end interior region 165 is substantially free of P-adsorbing material 166 so that it can be filled substantially only with influent wastewater 250I from upstream WAU 110.

In an example, front-end interior region 165 is defined in part by two opposing screens 180, with one at the upstream end of interior 162 adjacent MFU front end 152 and another axially displaced downstream by a distance equal to length L3 from the first screen so that it holds back P-adsorbing material 166. An example screen 180 is formed from metal and has openings sized to hold the smallest pieces 168 of P-adsorbing material 166. In an example, screens 180 are configured to filter solids 168 that are carried by influent wastewater 250I that flows into MFU 150.

With reference again to FIGS. 1A and 1B, HFD 214 is configured to divert the flow of influent wastewater 250I when the amount of influent wastewater exceeds the capacity of MFU 150. This situation may arise, for example, when there is excess precipitation (e.g., >1″ such as during spring snowmelt or storm events), or if the outflow source 260 of influent wastewater 250I otherwise generates a high influent wastewater flow rate. In such cases, flow control structure 60 can be adjusted to provide flow attenuation before influent wastewater 250I enters P-filter system 100. Likewise, freeboard interior region 164 allows MFU 150 to accommodate extra influent wastewater 250I when there is a high influent wastewater flow rate.

In an example, HFD 214 is configured to divert a portion of the influent wastewater 250I exiting the upstream WAU 110 and that travels toward the adjacent MFU 150. In an example, the portion of the diverted influent wastewater 250I is at least 25% of the amount of influent wastewater from the immediately adjacent and upstream WAU 110. In an example, the portion of influent wastewater 250I that is diverted by HFD 214 gradually increases as the flow rate increases until the diverted portion reaches a certain value (e.g., 25% of the total flow) at a certain threshold flow rate. Other percentages of diverted flow can be used and the 25% value associated with a threshold flow rate is cited as an exemplary value.

As discussed above, P-filter system 100 includes at least one MFU 150, and in some examples includes multiple MFUs. For example, five MFUs 150, each comprising one container 160 with a diameter D2 and a length L2 of about 1.5 m, can be used to effectively, treat influent wastewater 250I from a tile drain having a peak discharge rate of about 0.01 m³/s (0.37 ft³/s), e.g., a daily peak flow rate of about 900 m³/d (31950 ft³/d) and having a P concentration of 0.85 mg/L. MFUs 150 can be added to each other in series or in parallel in P-filter system 100 as modules or cartridges.

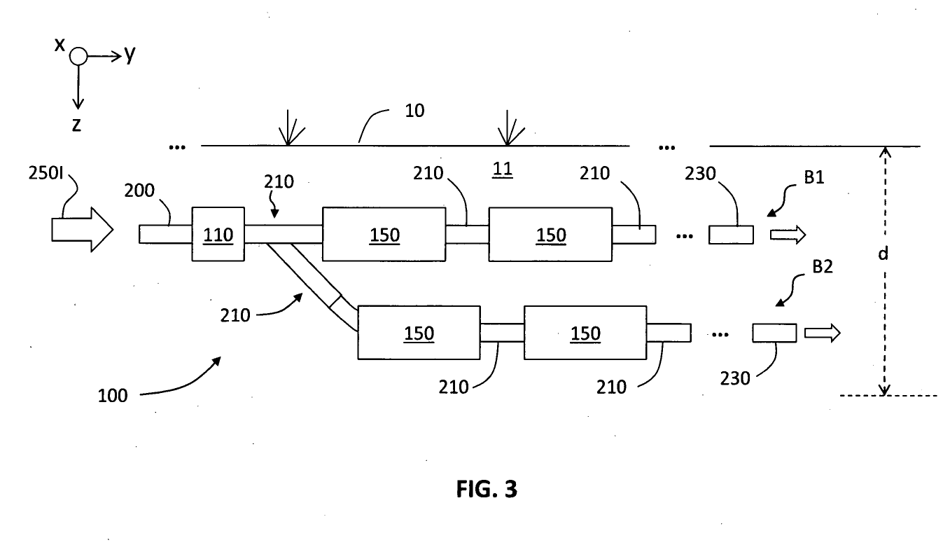

There are a variety of ways to configure P-filter system 100 to include multiple MFUs 150. FIG. 3 is a schematic side view of an example P-filter system 100 that includes two branches B1 and B2 that reside one above the other (relative to ground surface 10) and that each include at least one MFU 150. In an example, the deeper branch B2 is within a depth d of about 1 meter from ground surface 10.

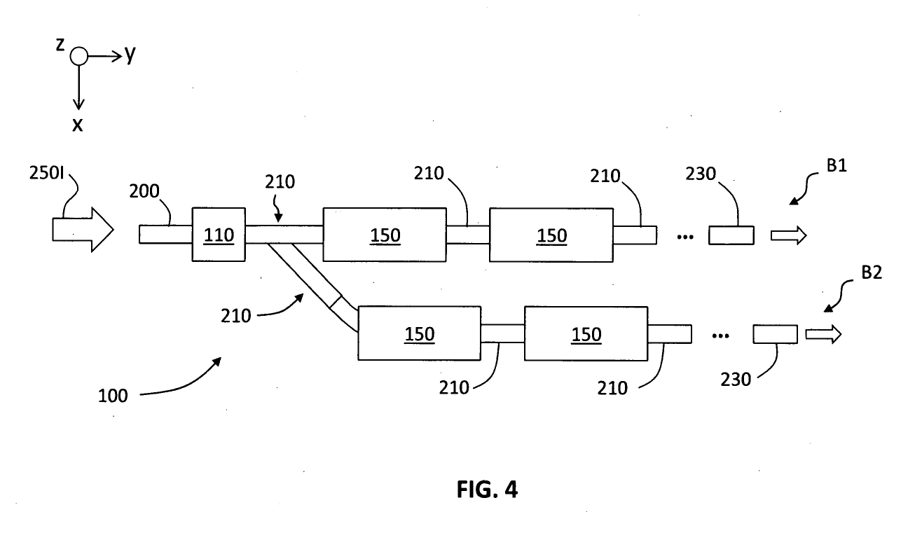

FIG. 4 is similar to FIG. 3 and shows an example P-filter system 100 where branches B1 and B2 reside in substantially the same plane (e.g., the x-y plane, as shown, which plane may necessarily be horizontal). The branches B1 and B2 can be, for example, at about the same depth d underground and can run generally parallel to one another. The branches B1 and B2 can also reside on or above ground surface 10.

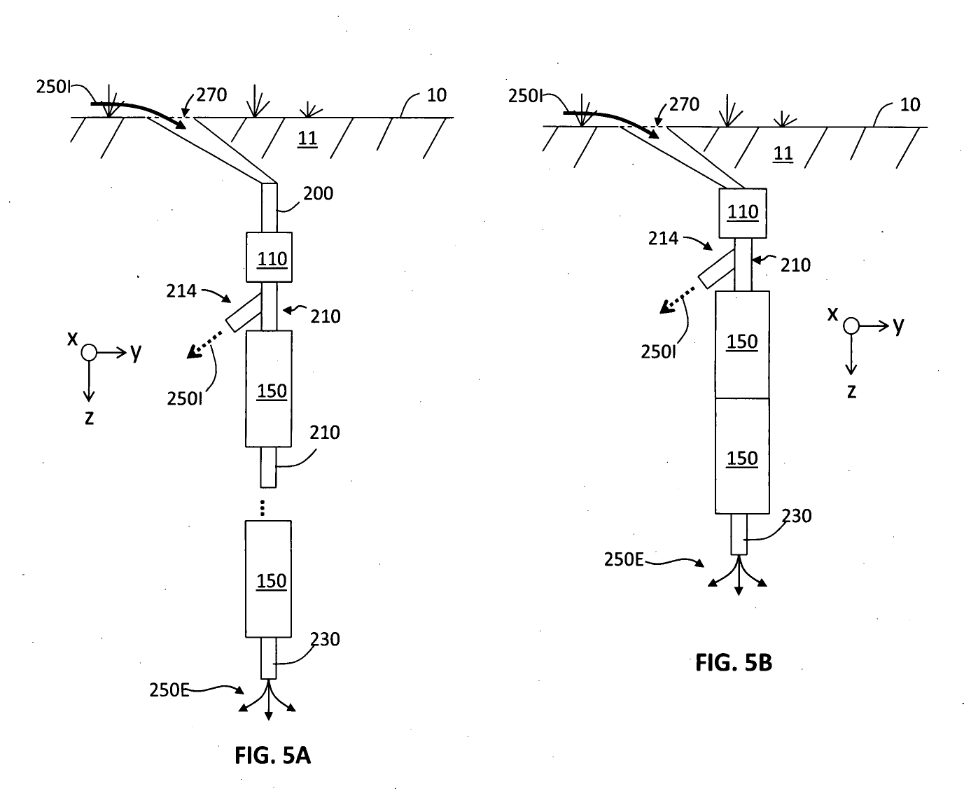

FIG. 5A is a schematic diagram of an example P-filter system 100 where a single branch extends downward (i.e., in the z direction) from ground surface 10 into ground 11 and includes at least one MFU 150. The P-filter system 100 of FIG. 5A is shown by way of example as being connected to a storm drain 270 that is open at ground surface 10. It is noted that P-filter system 100 need not be arranged directly vertically (i.e., directly in the z direction) and can be arranged at an angle relative to vertical.

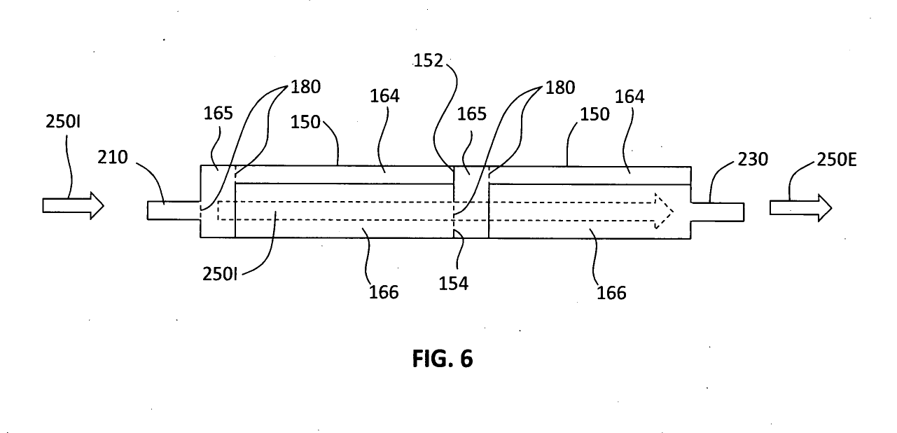

FIG. 6 is a close-up, cross-sectional view illustrating an example where MFUs 150 are arranged immediately adjacent one another, i.e., without an intervening connector pipe 210. This back-to-back configuration for MFUs 150 is illustrated in FIG. 5B, which is a modified version of P-filter system 100 shown in FIG. 5A except that connector pipes 210 between the MFUs have been removed. In this configuration, MFUs 150 are in direct fluid communication, with output end 154 of upstream MFU 150 directly fluidly connected to input end 152 of adjacent downstream MFU 150.

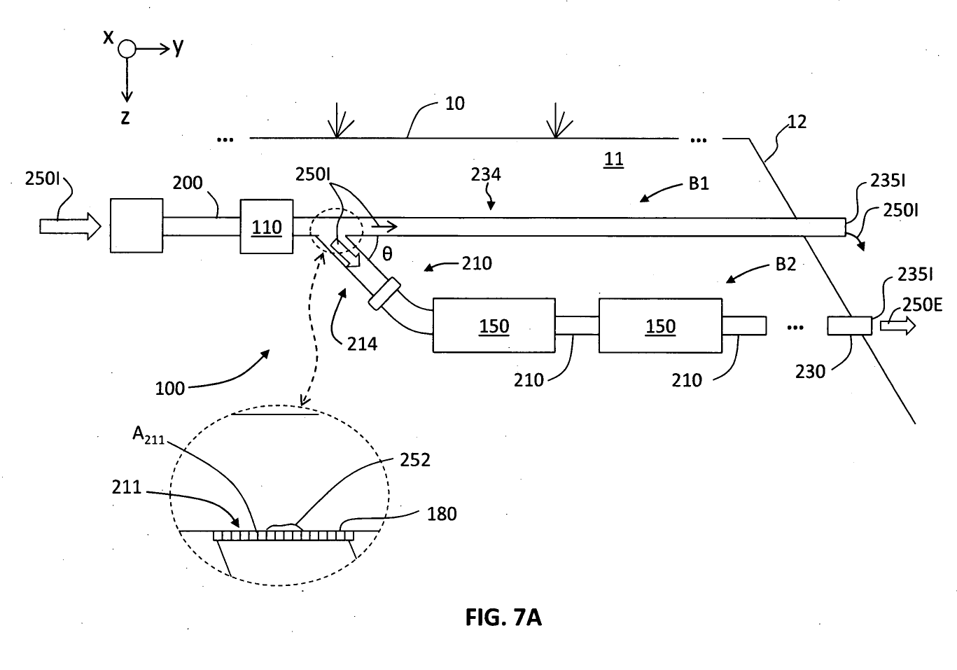

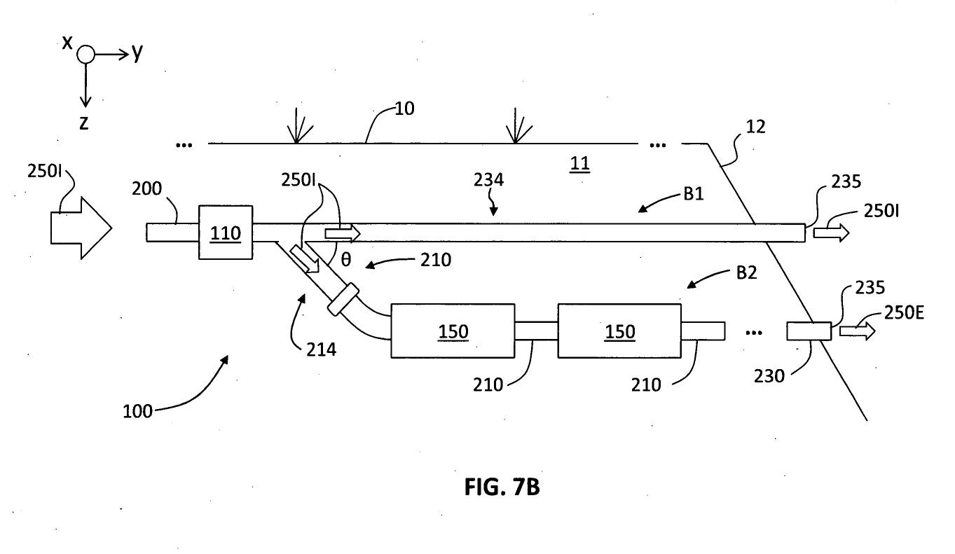

FIGS. 7A and 7B illustrate an example P-filter system 100 that includes two branches B1 and B2, where branch B1 includes an influent wastewater overflow discharge pipe 234 having an open end 235. The branch B2 connects up with branch B1 via connector pipe 210 and HDF 214, which is shown has having a pipe angle θ. The branch B2 includes at least one MFU 150. As shown in the close-up inset of FIG. 7A, connector pipe 210 has an open input end 211 with an area A₂₁₁. In an example, screen 180 covers open end 211 to filter any solids 252 that may be carried by influent wastewater 250I.

FIG. 7A illustrates the case where a flow rate R of influent wastewater 250I is “normal,” i.e., is not excessively high, so that P-filter system 100 can process the influent wastewater without backing up or overflowing. In this case, most (e.g., 90%) of influent wastewater 250I that flows into input pipe 200 drops down into connector pipe 210 through open input end 211. In an example, at least one of either area A₂₁₁ or pipe angle θ is selected so that at a given flow rate R, at least 90% of influent wastewater 250I flows into input pipe 200 and drops down into connector pipe 210 through open input end 211. FIG. 7A shows only a small amount of influent wastewater 250I being discharged from open end 235 of influent wastewater overflow discharge pipe 234.

FIG. 7B illustrates the case where the flow rate R of influent wastewater 250I is high, as indicated by the larger arrow representing influent wastewater entering input pipe 200. In this case, a large portion of the excess flow of influent wastewater 250I passes over open input end 211 and continues straight through influent wastewater overflow discharge pipe 234 and out of open end 235. This configuration prevents the one or more MFUs 150 from being flooded and backing up the flow of influent wastewater 250I.

In an example, influent wastewater 250I contains an initial amount of Escherichia coli (E. coli), and effluent wastewater 250E contains an amount of E. coli that is reduced by at least by 50% as compared to the initial amount.

In an example, effluent wastewater 250E discharged by P-filter system 100 has an amount of TSS that is at least 50% less than that of influent wastewater 250I.

It will be apparent to those skilled in the art that various modifications and variations can be made to the present disclosure without departing from the spirit and scope of the disclosure. Thus it is intended that the present disclosure cover the modifications and variations of this disclosure, provided they fall within the scope of the appended claims and their equivalents.

What is claimed is:

1. A P-filter system for removing phosphorous (P) from an influent wastewater having an initial P concentration and flow rate in a downstream direction and that carries solid material, comprising:
at least one water attenuation unit (WAU) configured to receive and attenuate the initial flow rate of the influent wastewater and to allow settling of the solid material carried by the influent wastewater;
at least one main filter unit (MFU) arranged downstream of and in fluid communication with the at least one WAU, the at least one MFU comprising P-adsorbing material that forms from the P-containing wastewater an effluent wastewater that contains less P than the influent wastewater; and
a high-flow diverter operably disposed between the at least one WAU and the at least one MFU, the high-flow diverter being configured to divert at least a portion of the influent wastewater from the at least one WAU from reaching the at least one MFU when the initial flow rate increases to a threshold flow rate.

2. The P-filter system of claim 1, wherein the high-flow diverter includes an angled pipe section that branches off from a connector pipe that fluidly connects the at least one WAU to the at least one MFU, wherein the angled pipe section has an open end that allows for the outflow of influent wastewater generally in the downstream direction.

3. The P-filter system of claim 1, wherein the threshold flow rate is defined by a storm flow associated with a precipitation event in excess of 1″.

4. The P-filter system of claim 1, further comprising multiple MFUs that are fluidly coupled either by one or more pipes or by being arranged immediately adjacent one another.

5. The P-filter system of claim 1, wherein the P-adsorbing material includes at least one type of slag.

6. The P-filter system of claim 1, wherein the at least one MFU includes an upstream input end and a downstream output end and includes an interior, wherein the system further comprises:
a first screen arranged in the interior adjacent the input end; and
a second screen spaced apart from and downstream of the first screen and substantially parallel thereto to define a front-end interior portion that is substantially free of P-adsorbing material, the first and second screens being configured to filter solid material from the influent wastewater that enters the at least one MFU.

7. The P-filter system of claim 1, wherein the at least one MFU includes an upstream input end and a downstream output end and includes an interior, wherein the P-adsorbing material only partially fills the interior to define a freeboard region sized to accommodate excess influent wastewater.

8. The P-filter system of claim 1, wherein the effluent wastewater has a total P concentration that is reduced by between 60-90% as compared to that of the influent wastewater.

9. The P-filter system of claim 1 having multiple MFUs, with the multiple MFUs being arranged in at least one of in series and in parallel with each other.

10. The P-filter system of claim 1, wherein the P-containing wastewater contains an initial amount of Escherichia coli (E. coli), and wherein the effluent wastewater reduces said initial amount of E. coli by at least by 50%.

11. The system of claim 1, wherein the P-containing wastewater contains an initial amount of Total Suspended Solids (TSS), and wherein the effluent wastewater has an output amount of TSS that is at least 50% less than the initial amount of TSS.

12. The system of claim 1, further comprising a flow control structure arranged upstream of and fluidly connected to the at least one WAU.

13. The system of claim 1, further comprising the high-flow diverter being configured to divert at least 25% of the influent wastewater.

14. A method of filtering an outflow of influent wastewater that contains a first amount of phosphorous (P), comprising:
flowing the influent wastewater through at least one water attenuation unit (WAU) to reduce a flow rate of the influent wastewater and to reduce an initial amount of total suspended solids in the influent wastewater;
flowing the influent wastewater from the at least one WAU to and through at least one main filter unit (MFU) that contains a P-adsorbing material to form an effluent wastewater that is discharged from the at least one MFU, the effluent wastewater having a second amount of P that is less than the first amount of P; and
wherein flowing the influent wastewater from the at least one WAU to and through the at least one MFU includes diverting at least a portion of the influent wastewater from the at least one WAU from reaching the MFU when initial flow rate reaches a threshold flow rate.

15. The method of claim 14, wherein the diverting the influent wastewater includes directing the influent wastewater through a high-flow diverter operably disposed between the at least one WAU and the at least one MFU.

16. The method of claim 14, further comprising disposing at least one of the at least one WAU, the high-flow diverter and the at least one MFU above ground.

17. The method of claim 14, further comprising forming the effluent wastewater to have a total P concentration that is between 60-90% less than that of the influent wastewater.

18. The method of claim 14, wherein the influent wastewater contains an initial amount of Escherichia coli (E. coli), and further comprising forming the effluent wastewater to have an amount of E. coli that is less than 50% of the initial amount of E. coli.

19. The method of claim 14, wherein the influent wastewater contains an initial amount of Total Suspended Solids (TSS), further comprising forming the effluent wastewater to have an output amount of TSS that is at least 50% less than the initial amount of TSS.

20. The method of claim 14, wherein the P-adsorbing material only partially fills the interior to define a freeboard region, and including flowing the influent wastewater through the freeboard region.

21. The method of claim 14, further comprising flowing the influent wastewater through a flow control structure.

22. The method of claim 14, further comprising said diverting including diverting at least 25% of the influent wastewater.
